(19) United States
(12) Patent Application Publication
(10) Pub. No.: US 2010/0251710 A1
(43) Pub. Date: Oct. 7, 2010

(54) SYSTEM FOR UTILIZING RENEWABLE GEOTHERMAL ENERGY

(76) Inventor: Francisco Javier CUMPLIDO MATESANZ, Logrono (La Rioja) (ES)

Correspondence Address: WENDEROTH, LIND & PONACK, L.L.P., 1030 15th Street, N.W.,, Suite 400 East, Washington, DC, 20005-1503, US

(21) Appl. No.: 12/755,469

(22) Filed: Apr. 7, 2010

(30) Foreign Application Priority Data
Apr. 7, 2009 (ES) P200900953

(51) Int. Cl. F03G 7/00

(52) U.S. Cl. 60/641.2

(57) ABSTRACT

In the system there is a geothermal facility (1) including an outer circuit of heat-carrying water or fluid which exchanges heat energy with a terrain (3) to be applied in at least one dwelling unit (2) by means of its connection to a heat pump (5) which in turn connects to an inner distribution equipment or circuit (6). The referred outer circuit is placed buried in a renewable geothermal zone (4) of the terrain (3) and is made up of a closed/semiclosed circuit which connects to the heat pump (5) via a pulse pipe (7) and a return pipe (11); being arranged in that outer circuit a special channel (8) wherein the energy exchange is performed, so that the heat-carrying water or fluid is thermally regenerated as it passes through this channel (8) to be used again in the system.

### OBJECT OF THE INVENTION

The present invention, as expressed in the statement of this specification, relates to a system for utilizing renewable geothermal energy with its essential purposes being of eliminating the drawbacks derived from the limitation and lack of water springs, to carry out a renewable utilization of the terrain, as well as to reduce the installation costs of a geothermal system, in comparison with non-renewable systems which need carrying out considerable drillings. For that purpose, the circuit of the invention has an outer circuit which is buried in a renewable geothermal zone and having a special channel wherein, in closed/semiclosed circuit, an energy exchange is performed for the heat-carrying water or fluid to be thermally regenerated as it passes through said channel and to be used again in the system.

The invention is framed in the sector of renewable energies, namely in the utilization of the internal energy of the terrain for its subsequent application in facilities for air conditioning, heating or any other system which needs a gain or release of heat or energy. With the invention, a system of energy exchange between fluid and terrain is developed which eliminates problems of water loss in the process of geothermal energy exchange, so that the water, determinant of the heat-carrying fluid, ceases to be a limiting factor and the cost of carrying out the corresponding installation decreases with respect to conventional systems, not being necessary in the present system to carry out a large number of drillings in the terrain, nor be very deep. By means of the invention, a sustainable and renewable geothermal system is obtained, wherein neither the terrain or the water as heat-carrying fluid are limiting factors of the facility and wherein said facility has some costs lower than the ones of the systems for utilizing conventional geothermal energy.

### BACKGROUND OF THE INVENTION

The geothermal facilities are known which utilize the thermal inertia of the Earth at depths from a few meters to several kilometers in depth in order to obtain water at a temperature suitable for its use and utilization in facilities for heating, air conditioning or similar ones.

In a geothermal facility, the terrain serves as a means for taking up heat in the winter months, while in the summer times serves as a means of a release of the generated heat and which is desired to be dispersed.

Basically, a conventional geothermal facility is made up of the following elements:
Outer water circuit: in charge of the movement and take up of outer water, serving as a water feeding system to a heat pump machine in its condensation circuit, besides exchanging energy with the terrain, utilizing the energy existent in the terrain.
Heat pump machine: essentially made up of compressor, condenser, evaporator, and expansion system, among other auxiliary elements, being in charge of exchanging energy between a refrigerating fluid (which has previously taken up cold or heat from the outer water) and the fluid object of treatment (air or water).
Inner distribution circuit: based on this inner distribution circuit or equipment, the treated and conditioned air or water, as to its temperature and moisture, is taken to the zones or premises desired to be maintained in certain conditions of comfort, a thermal exchange being produced.

The geothermal system can function in open loop in the case that it is arranged in the terrain of a water source of a well, river, reservoir, irrigation ditch or lake, such that a collecting pipe draws out the water and it sends it to the heat exchange of the heat pump, releasing or taking up heat and returning thereafter, without getting polluted by the process.

Another variation of the geothermal system is by means of a closed loop, wherein pipelines buried in the subsoil, horizontal, vertical or submerged in considerable volumes of water, form the outer water circuit, such that in its interior circulates water propelled by means of a circulation group. These pipelines function as a heat exchange wherein the circulating water takes heat in the winter months, releases it in the terrain in the summer months.

In the state of the art that we know, various types of facilities are observed. In this way, in the Patent document with publication number ES 2005556, a geothermal utilization system is described, where the water that feeds the outer circuit is taken from hot water tables of the terrain, presenting the problems of having a natural resource of limited duration.

In other facilities, such as the ones indicated in the Patent document with publication number ES 2019734, rocky zones are used in order to carry out probes of considerable depth, arranging inside the probe a water circulation circuit which exchanges energy with the terrain. In this type of facilities, in order to prevent the depletion of the terrain, since the rocks transmit heat badly, several probes should be carried out at different points of the terrain, to alternate its use, in this way letting the terrain rest in order for it to charge with energy, which represents drawbacks relative to a high installation cost.

Variations of geothermal facility exist wherein geothermal panels or collectors are installed, on which the fluid circulates by some panels with tubes inside them, arranged in the ground, as indicated in the Patent document with publication number ES 2279702.

Most of the current facilities which use geothermal energy carry out probes in the terrain of a certain depth, associated or not with a well, through which water circulates that will be the one in charge of taking up or giving up the energy, as for example in Patent documents Nos. 2132658 and 2246476.

The Patent document with publication number US 6250371, describes a geothermal facility wherein its operation is regulated in function of the entry and exit temperatures of the water. As an outer facility of heat exchange, it describes the building of wells filled with a heat-conducing material in order to facilitate the exchange between heat-carrying fluid and ground. In the same way, the Patent document with publication number DE202004014113U develops a geothermal facility wherein it is needed to execute a vertical probe, wherein a corrugated tube should be arranged, filled with bentonite, with an interior through which the ducts circulate which serve as means of exchange between terrain and heat-carrying fluid. Finally to mention the Patent document with publication number US 526151, wherein the terrain-heat-carrying fluid exchange system consists of a series of horizontally buried tubes.

The systems to which all these documents refer, present drawbacks relative to that they need carrying out a large number of probes, both vertical (which extend at a considerable depth) and horizontal.

The current systems of geothermal take up can be superficial, utilizing the renewable energy from the ground up to a depth of 20 meters, or very deep, obtaining energy from 20 meters onwards in depth. Among them, the ones that operate by means of drawing out water (aquifers, water springs or other water sources), with more or less temperature, are the most common ones.

From what has been exposed, two main drawbacks can be observed in the current geothermal facilities:
The temporary limitation of water, since many facilities take water from different natural sources, but they do not reutilize it, but they return it under different conditions to the initial ones. Likewise, there can be cases of the aquifers running out, the water spring being diverted to wells for other uses, presence in construction area, and other limitations in gaining water.
High economical costs derived from carrying out probes of considerable depth, or of a large number of probes for the water-terrain exchanger.

### DESCRIPTION OF THE INVENTION

For achieving the objectives and avoid the drawbacks indicated in the previous sections, the invention consists of a system for utilizing renewable geothermal energy, wherein there is a geothermal facility including an outer circuit with heat-carrying water or fluid which exchanges heat energy with a terrain in order to be applied in at least one dwelling unit by means of its connection to a heat pump which in turn is connected to an inner distribution equipment or circuit.

Innovatively, according to the invention, the referred outer circuit is placed buried in a renewable geothermal zone of the terrain and it is made up of a closed/semiclosed circuit which connects to the heat pump via a pulse pipe and a return pipe; in that outer circuit a special channel being arranged wherein the energy exchange is performed, so that the heat-carrying water or fluid is thermally regenerated as it passes through this channel to be used again in the system.

Optionally, according to a preferred embodiment of the invention, in the referred outer circuit, a tank or well having a certain depth is arranged which connects to the special channel and to the return pipe.

The above-mentioned special channel can present a variable dimensioning, geometry, composition, and placement in function of the specific application of the system; inside thereof able to be provided with a bed made up of a special material which facilitates the energy exchange.

On the other hand, the above-mentioned return pipe should have a circulation system, which can be a circulating pump.

With the structure that has been described, the system of the invention presents the following main advantages: The special channel makes possible the take up, movement, exchange, and recovery of the heat-carrying fluid as it passes through the renewable zone of the terrain, becoming available for the geothermal system, so that in this way the problems of water limitation existing in conventional systems are eliminated.

Moreover, the system of the invention, allows for a lower cost of facility execution, since it is not necessary to carry out a large number of drillings in the terrain, nor that said drillings would be very deep. Thus, a sustainable and renewable geothermal system is achieved wherein neither the terrain nor the water as heat-carrying fluid are limitating factors of the facility.

The present invention, by means of a novel method of reutilizing the water of the outer circuit of the system, fundamentally eliminates the problem of water availability, by developing a system for utilizing renewable and sustainable geothermal energy over time, such that the water used in the outer circuit of exchange with the terrain flows by a novel energy exchange which serves as means of take up, movement and recovery of said water, becoming available again for the heat exchange in the heat pump of the system, also preventing carrying out a considerable number of probes in the terrain as required by other systems, as well as a lower depth than the one required by conventional systems.

On the other hand, the special channel of the system of the invention presents advantages relative to that it can present a path with very different layouts and geometries, as well as dimensions and placements, even able to flow below the building or dwelling unit wherein the system is applied, in this way eliminating problems of space limitation outside of that building.

Another advantage of the invention consists of the special material for the bed of the special channel and more energy utilization; also being an advantage the optional inclusion of a well or tank for a more stable and continuous operation of the corresponding geothermal facility, such that by placing the well or tank at the exit of the special channel, the thermally regenerated water can be stored in order to be taken by the corresponding heat pump in a direct manner, or through an electrical pump included in the return pipe.

Next, for facilitating a better understanding of this specification and forming an integral part thereof, a single figure is attached in which the object of the invention has been represented in an illustrative but not limitative manner.

### BRIEF DESCRIPTION OF THE FIGURE

FIG. 1.—Represents a schematic and functional block level view of a system for utilizing renewable geothermal energy, carried out according to the present invention.

### DESCRIPTION OF AN EMBODIMENT OF THE INVENTION

Next, a description is carried out of an example of the invention, referring to the number adopted by the FIGURE.

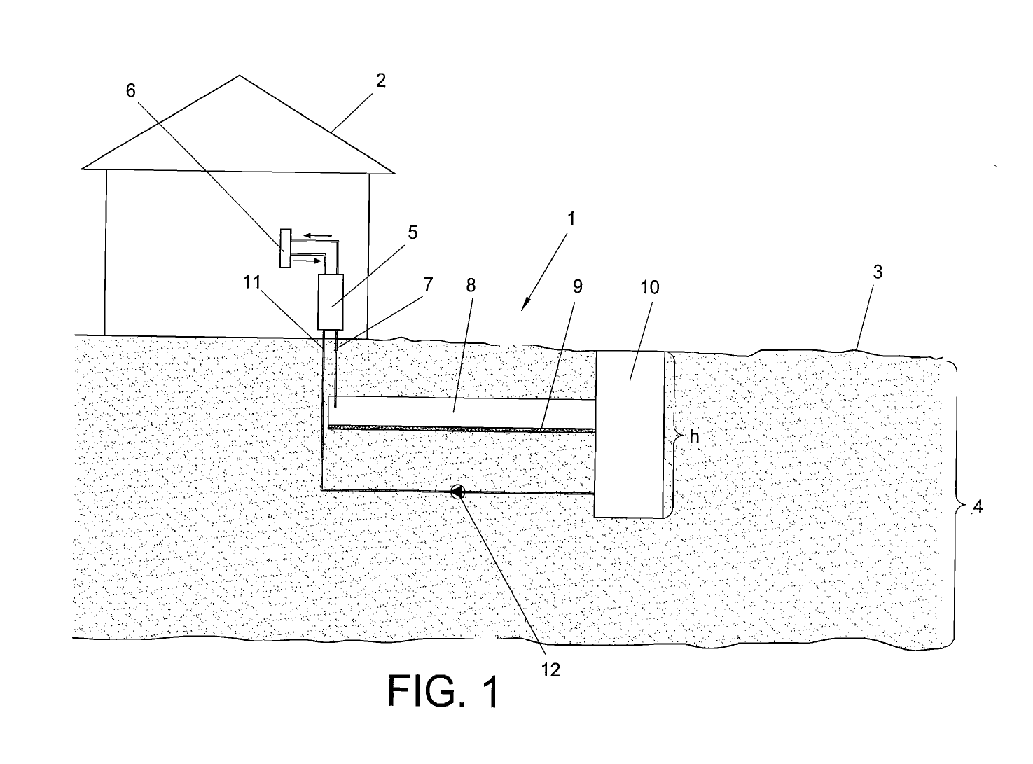

In this way, as observed in FIG. 1, the system of the present example consists of a geothermal facility 1 applied to a conventional dwelling unit 2, or group of dwelling units, having an indoor environment to be climatized by means of gaining heat or cold according to an operating cycle, for which a geothermal heat pump machine 5 is installed wherein the production of heating or refrigerating energy, according to the working cycle, fulfils the energy needs of the dwelling unit 2. By means of this heat pump 5, the heat or cold necessary by the dwelling unit 2 are taken from the surrounding outer terrain 3. For that purpose, the heat pump 5, by means of mechanical compression technology, is able to transmit heat or cold between the terrain 3 and the inside of the dwelling unit 2.

The heat pump 5 gives up produced energy to a distribution equipment 6 made up of mainly distribution means and energy emitting means, such as radiators, radiating floor, fan-coils, or another energy delivery system.

The geothermal heat pump 5 operates by means of a water-water system, wherein the produced heat (in summer) in the refrigerating cycle and from the inside of the dwelling unit 2 is given up to a heat-carrying fluid (in this case, water), while in winter it is the heat-carrying fluid which gives up heat to the heat pump 5. In order to carry out such a function, a pulse pipe 7 of heat-carrying fluid to the outside is arranged, as well as a return pipe 11 of heat-carrying fluid from the outside, which connect to the pump 5, as illustrated in FIG. 1. From these pipes 7 and 11 to the outside, the outer circuit of the system is made.

These pulse 7 and return 11 pipes are buried, the same as the rest of the referred outer circuit, in a renewable geothermal zone 4 of the terrain 3.

In the return pipe 11, a circulation system 12 is arranged in order to attain the return of the heat-carrying fluid.

The exchange of heat between the heat-carrying fluid and the terrain is done via a special channel 8, preferably, made of concrete, among other materials of possible utilization, with section, depth, length, composition, and layout suitable for the specific application and inside it a bed of special material 9 has been placed which facilitates the energy exchange between the heat-carrying fluid and the terrain. In this way, this special channel 8 takes up the heat-carrying fluid from the pulse pipe 7 from the heat pump 5. Said taken up fluid flows via the channel 8 along its entire length, exchanging energy with the terrain, recovering at the end thereof the temperature suitable to be used again by the heat pump 5. Thus, the special channel 8 makes possible the take up, movement, and recovery of heat-carrying fluid in the outer circuit.

In the winter cycle, the heat-carrying fluid, which will be colder than the terrain 3 takes up heat from said terrain 3, while in summer the heat-carrying fluid gives up to the terrain 3 the heat that it has taken up from the inside of the dwelling unit 2.

Optionally, a well or tank 10 can be arranged having a depth h to take up the heat-carrying fluid once it has passed via the special channel 8 and it has regenerated, as illustrated in FIG. 1, in this way making possible a more stable and continuous operation of the system.

As mentioned above, all the facility corresponding to the outer circuit is installed inside of the renewable geothermal zone 4 of the terrain 3, so that all the depths of the facility have a bound in said renewable geothermal zone 4.

1. SYSTEM FOR UTILIZING RENEWABLE GEOTHERMAL ENERGY, wherein there is a geothermal facility including an outer circuit of water or heat-carrying fluid that exchanges heat energy with a terrain (3) to be applied in at least one dwelling unit (2) by means of connecting it to a heat pump (5) which in turn connects to an inner distribution equipment or circuit (6); characterized in that the referred outer circuit is placed buried in a renewable geothermal zone (4) of the terrain (3) and is made up of a closed/semiclosed circuit connecting to the heat pump (5) via a pulse pipe (7) and a return pipe (11); a special channel (8) being arranged in that outer circuit wherein the energy exchange is performed, such that the water or heat-carrying fluid is thermally regenerated as it passes through this channel (8) to be used again in the system.

2. SYSTEM FOR UTILIZING RENEWABLE GEOTHERMAL ENERGY, according to claim 1, characterized in that in said outer circuit a tank or well (10) having a certain depth (h) which connects to the special channel (8) and to the return pipe (11), is arranged.

3. SYSTEM FOR UTILIZING RENEWABLE GEOTHERMAL ENERGY, according to claim 1, characterized in that the special channel (8) presents varied dimensioning, geometry, composition, and placement in function of the specific application of the system; inside of it being provided with a bed made of special material (9) which facilitates the energy exchange; and preferably made up from concrete, among other materials of possible utilization.

4. SYSTEM FOR UTILIZING RENEWABLE GEOTHERMAL ENERGY, according to claim 1, characterized in that the return pipe (11) has a circulating pump (12), or another circulation system.

5. SYSTEM FOR UTILIZING RENEWABLE GEOTHERMAL ENERGY, according to claim 2, characterized in that the special channel (8) presents varied dimensioning, geometry, composition, and placement in function of the, specific application of the system;
inside of it being provided with a bed made of special material (9) which facilitates the energy exchange; and preferably made up from concrete, among other materials of possible utilization.

6. SYSTEM FOR UTILIZING RENEWABLE GEOTHERMAL ENERGY, according to claim 2, characterized in that the return pipe (11) has a circulating pump (12), or another circulation system.

7. SYSTEM FOR UTILIZING RENEWABLE GEOTHERMAL ENERGY, according to claim 3, characterized in that the return pipe (11) has a circulating pump (12), or another circulation system.
